(19) United States
(12) Patent Application Publication
(10) Pub. No.: US 2011/0222452 A1
(43) Pub. Date: Sep. 15, 2011

(54) METHOD AND APPARATUS FOR POWER CONTROL IN WIRELESS COMMUNICATION SYSTEM

(75) Inventors: Su-Ryong JEONG, Suwon-si (KR); Jeong-Ho PARK, Seoul (KR)

(73) Assignee: Samsung Electronics Co., Ltd., Suwon-si (KR)

(21) Appl. No.: 13/042,874

(22) Filed: Mar. 8, 2011

(30) Foreign Application Priority Data
Mar. 9, 2010 (KR) 10-2010-0020985

(51) Int. Cl. H04W 52/04

(52) U.S. Cl. 370/311

(57) ABSTRACT

An apparatus and a method for transiting from one power control scheme to another power control scheme when power control schemes are used in a wireless communication system are provided. A method of a terminal for changing a power control scheme in a wireless communication system includes controlling power according to a first power control scheme based on first power control parameters received from a base station, receiving second power control parameters to use in a second power control scheme, from the base station, sending a power control transition message informing the base station of a transition of the power control scheme, to the base station, and controlling the power according to the second power control scheme using the second power control parameters.

### PRIORITY

This application claims the benefit under 35 U.S.C. §119(a) to a Korean patent application filed in the Korean Intellectual Property Office on Mar. 9, 2010, and assigned Serial No. 10-2010-0020985, the entire disclosure of which is hereby incorporated by reference.

### BACKGROUND OF THE INVENTION

1. Field of the Invention

The present invention relates to an apparatus and a method for power control in a wireless communication system. More particularly, the present invention relates to an apparatus and a method for transitioning from one power control scheme to another power control scheme when a plurality of power control schemes are used in a wireless communication system.

2. Description of the Related Art

Research is being conducted on next-generation communication systems to provide users with services of various Quality of Service (QoS) levels at a high data rate. Support for high speed services by guaranteeing mobility and QoS in Broadband Wireless Access (BWA) communication systems such as Wireless Local Area Network (WLAN) systems and Wireless Metropolitan Area Network (WMAN) systems is being developed. Representative communication systems include the Institute of Electrical and Electronics Engineers (IEEE) 802.16a/d communication system and the IEEE 802.16e/m communication system.

The IEEE 802.16a/d communication system and the IEEE 802.16e/m communication system of the BWA communication systems adopt an Orthogonal Frequency Division Multiplexing (OFDM)/Orthogonal Frequency Division Multiple Access (OFDMA) scheme in order to support a broadband transmission network in a physical channel of the WMAN system. The IEEE 802.16a/d communication system takes into account only a single cell structure for a subscriber terminal. The IEEE 802.16a/d communication system does not consider the mobility of the subscriber terminal. On the other hand, the IEEE 802.16e/m communication system takes into account the mobility of the subscriber terminal in the IEEE 802.16a communication system.

A wireless communication system requires a certain power control algorithm for transmit signals, in order to compensate for propagation attenuation, a shadow effect, and internal/external interference of the transmit signal, to satisfy a target signal to interference and noise ratio, and to thus achieve successful signal transmission. Power control schemes may be classified into a downlink power control scheme and an uplink power control scheme according to a direction of the power control, and into an open-loop power control scheme and a closed-loop power control scheme according to whether a transmitter (e.g., a terminal) receives feedback information from a receiver (e.g., a base station).

In the downlink power control scheme, a base station fulfills the power control. When the base station and a terminal are close to each other; that is, when the terminal travels in the center of the coverage area of the base station or a channel state is good because there are no shadows formed by obstacles, the base station diminishes interference to other neighbor base stations by sending signals with as low transmit power as possible. When the channel state is poor, the base station controls to increase the transmit power so that the receiver may normally receive the transmit signal of the base station. When the base station increases the transmit power, the resulting transmit power should remain within the possible range of the transmit power.

In the uplink power control scheme, the terminal manages the power control by inverting the functions of the terminal and the base station in the downlink power control scheme.

In the open-loop power control scheme, a transmitter (the base station or the terminal) manages the power control by independently determining the channel state of the receiver based on reversibility of an uplink channel and a downlink channel. The reversibility of the uplink channel and the downlink channel indicates that the uplink and downlink channels suffer from similar path loss when locations of the base station and the terminals are the same because of path loss due to the distance between the base station and the terminals which determines the channel quality, an antenna gain based on an antenna pattern, a shadow effect of geographical features, and multipath fading. In the open-loop power control scheme, the transmitter itself predicts signal reception quality of the receiver based on the reversibility of the uplink and downlink channels and controls the necessary transmit power based on the prediction.

The closed-loop power control scheme controls the transmit power as required, based on the signal reception quality of the receiver received over a feedback channel, unlike the open-loop power control scheme in which the transmitter independently determines the channel state of the receiver. The closed-loop power control scheme suffers from overhead resulting from the feedback channel, but the transmitter may know the channel state of the receiver. Accordingly, the closed-loop power control scheme may control the size of the transmit signal more accurately than the open-loop power control scheme.

Recent communication systems adopting the OFDM/OFDMA technology are using the open-loop power control scheme as their main power control scheme. The closed-loop power control scheme causes considerable overhead. While conventional methods send continuous correction feedback based on continuous circuit signal transmission, current packet communications using the OFDM/OFDMA generate much data transmission discontinuously and irregularly and thus have difficulty in setting the feedback value and controlling the power.

An open-loop power control equation of the uplink power control scheme mainly used in the current IEEE 802.16m system includes a plurality of power control parameters that are received directly from the base station using a System Configuration Descriptor (SCD) message or an Uplink Power Control Noise plus Interference (ULPC_NI) message, in addition to power control parameters measured by the terminal itself. The transmission of a plurality of the power control parameters causes the overhead. As a result, the terminal has difficulty in receiving a plurality of the power control parameters through frequent period transmission or superframe header transmission. The terminal should receive a plurality of the power control parameters based on a period over a certain time. In this regard, a separate power control scheme is required until the terminal receives a plurality of the power control parameters.

In addition, the terminal should transmit uplink signals several times, even in the initial network entry. For doing so, the uplink power control scheme should be defined. When the terminal fails to receive a plurality of the power control parameters, appropriate uplink power control is not conducted or the network entry and the data transmission are delayed. Accordingly, a separate power control scheme is used until the terminal receives a plurality of the power control parameters.

The separate power control scheme used before the plurality of the power control parameters are received is referred to herein as a first power control scheme, and a power control scheme used after the power control parameters are received is referred to as a second power control scheme. The first power control scheme compensates and controls the power using the closed loop or the feedback value of a specific time based on the transmission success power of an initial ranging signal which is the initial signal, before the second power control scheme is applied.

As discussed above, the uplink of the wireless communication system may apply the first power control scheme until the terminal receives all of the power control parameters relating to the second power control scheme and then transition to the second power control scheme. When receiving all of the power control parameters for the second power control scheme and completing the uplink transmission preparation using the second power control scheme, the terminal stops using the first power control scheme and attempts the uplink transmission using the second power control scheme. However, since most of the power control parameters transmitted by the base station are for unspecified terminals, not a specific terminal, they are transmitted using a broadcast message. Naturally, the base station may not determine whether the terminal receives all or part of the power control parameters.

In the first power control scheme and the second power control scheme, when the terminal arbitrarily changes its power control scheme, the base station may not be able to predict or recognize the transition of the power control scheme used by the terminal based on the definitions so far. As a result, accuracy of the power control deteriorates and the system performance degrades. Especially, at the transition point of the first power control scheme and the second power control scheme, the schemes applied to the base station and the terminal are different from each other with respect to the same signal and, disadvantageously, error in the system operation rises.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for transiting power control in a wireless communication system.

Another aspect of the present invention is to provide an apparatus and a method for transitioning from one power control scheme to another power control scheme when power control schemes are used in a wireless communication system.

Another aspect of the present invention is to provide an apparatus and a method for sending a power control transition message to a base station when a plurality of power control schemes are used in a wireless communication system, a transition from one power control scheme (i.e., a first power control scheme) to another power control scheme (i.e., a second power control scheme) is needed, and the latter power control scheme (i.e., the second power control scheme) is ready before a terminal changes the power control scheme.

Another aspect of the present invention is to provide an apparatus and a method of a terminal for determining a difference between a transmit power value determined in a second power control scheme and a previous transmit power value determined and transmitted in a first power control scheme, and sending a result value to a base station together with a power control transition message in a wireless communication system.

Another aspect of the present invention is to provide an apparatus and a method for maintaining data transmission efficiency before transition even when a power control scheme is changed in a wireless communication system.

According to an aspect of the present invention, a method of a terminal for changing a power control scheme in a wireless communication system is provided. The method includes controlling power according to a first power control scheme based on first power control parameters received from a base station, receiving second power control parameters to use in a second power control scheme, from the base station, sending a power control transition message informing the base station of a transition of the power control scheme, to the base station, and controlling the power according to the second power control scheme based on the second power control parameters.

According to another aspect of the present invention, a method of a base station for changing a power control scheme in a wireless communication system is provided. The method includes sending, to a terminal, first power control parameters for a first power control scheme outside a second power control parameter transmission time, and sending, to the terminal, second power control parameters for a second power control scheme at the second power control parameter transmission time, receiving, from the terminal, a power control transition message informing of change of a power control scheme, and modifying power control scheme information of the terminal.

According to another aspect of the present invention, an apparatus of a terminal for changing a power control scheme in a wireless communication system is provided. The apparatus includes a receiver for receiving at least one of first power control parameters and second power control parameters from a base station, a power controller for controlling power according to a first power control scheme based on the first power control parameters received from the base station through the receiver, when receiving the second power control parameters to use in a second power control scheme from the base station, for controlling the sending of a power control transition message informing the base station of a transition of the power control scheme, to the base station, and for controlling the power according to the second power control scheme using the second power control parameters, and a transmitter for sending the power control transition message to the base station.

According to another aspect of the present invention, an apparatus of a base station for changing a power control scheme in a wireless communication system is provided. The apparatus includes a transmitter for sending, to a terminal, first power control parameters for a first power control scheme outside a second power control parameter transmission time, and for sending, to the terminal, second power control parameters for a second power control scheme at the second power control parameter transmission time, a receiver for receiving, from the terminal, a power control transition message informing the base station of a change of a power control scheme, from the terminal, and a power controller for modifying power control scheme information of the terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a signal flow diagram of an initial network entry process of an IEEE 802.16m system according to related art;

FIG. 2 is a signal flow diagram of a method of a terminal for generating and sending a power control transition message before changing a power control scheme in a wireless communication system according to an exemplary embodiment of the present invention;

FIGS. 3A and 3B are flowcharts of a method of a terminal for sending a power control transition message to a base station before changing a power control scheme in a wireless communication system according to an exemplary embodiment of the present invention;

FIG. 4 is a flowchart of a process of a terminal for sending a power control transition message to a base station in a wireless communication system according to an exemplary embodiment of the present invention;

FIG. 5 is a flowchart of a process of a terminal for sending a power control transition message to a base station in a wireless communication system according to an exemplary embodiment of the present invention;

FIG. 6 is a flowchart of a method of a base station for receiving a power control transition message from a terminal in a wireless communication system according to an exemplary embodiment of the present invention;

FIG. 7 is a flowchart of a method of a base station for receiving a power control transition message from a terminal in a wireless communication system according to an exemplary embodiment of the present invention;

FIG. 8 is a flowchart of a process of a base station for receiving a power control transition message from a terminal in a wireless communication system according to an exemplary embodiment of the present invention;

FIG. 9 is a flowchart of a process of a base station for receiving a power control transition message from a terminal in a wireless communication system according to an exemplary embodiment of the present invention;

FIG. 10 is a block diagram of a base station in a wireless communication system according to an exemplary embodiment of the present invention; and

FIG. 11 is a block diagram of a terminal in a wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein may be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a method for changing from one power control scheme to another power control scheme when the power control schemes are used in a wireless communication system. In particular, exemplary embodiments of the present invention provide a method for changing from a first power control scheme to a second power control scheme when uplink power control schemes are adopted in a wireless communication system.

Hereinafter, while an Institute of Electrical and Electronics Engineers (IEEE) 802.16m system is explained by way of example, one or more power control schemes may be used in the uplink. Exemplary embodiments of the present invention are applicable to every wireless communication system which needs to change its power control scheme.

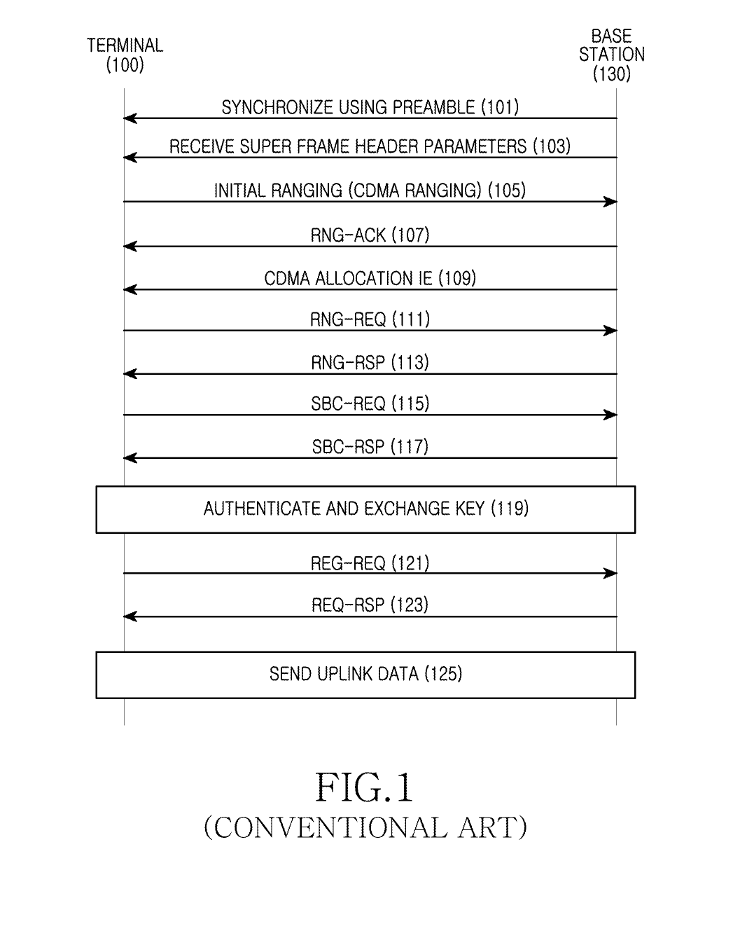

An initial network entry process when a terminal commences its access to a communication network in the IEEE 802.16m system is illustrated with respect to FIG. 1.

FIG. 1 is a signal flow diagram of an initial network entry process in an IEEE 802.16m system according to related art.

Referring to FIG. 1, at the point of the initial network entry, a terminal 100 synchronizes to the downlink using a preamble of a downlink signal received from a base station 130 of a corresponding cell in step 101.

The terminal 100 obtains unique characteristics and parameter values in the cell by decoding a Super Frame Header (SFH) of the downlink signal received from the base station 130 in step 103.

To commence the uplink synchronization and the network entry procedure, the terminal 100 sends an initial ranging signal over a band designated by the base station 130 as a ranging channel in step 105.

The base station 130 successfully receiving the initial ranging signal informs the terminal 100 of the successful reception of the initial ranging signal and sends frequency, time, and power correction values for the terminal 100 by sending a RaNGing ACKnowledge (RNG-ACK) message to the terminal 100 in step 107.

The base station 130 sends a channel, a transmission scheme, and a Modulation and Coding Scheme (MCS) level for carrying a RNG-REQuest (REQ) message, by sending Code Division Multiple Access (CDMA) allocation Information Element (IE) to the terminal 100 according to the network entry procedure in step 109. The terminal 100 receiving the CDMA allocation IE sends a RNG-REQ message to the base station 130 using the corresponding subchannel and MCS level in step 111.

The base station 130, upon successfully receiving the RNG-REQ message, informs the terminal 100 of the successful reception of the RNG-REQ message and allocates a temporary STation ID (STID) to use to identify the corresponding terminal 100 within the cell until a formal STID is allocated, by sending a RNG-ReSPonse (RSP) message to the terminal 100 in step 113.

The terminal 100 allocated the temporary STID may request uplink resource allocation to the base station 130 using a Bandwidth Request (BR) message, and receive its unique downlink signal and data from the base station 130. By sending the BR message to the base station 130, the terminal 100 may request the band to carry a Subscriber Station (SS) Basic Capability (SBC)-REQ message. The terminal 100 may be allocated the channel for carrying the SBC-REQ message from the base station 130, or the base station 130 itself may allocate a channel for carrying the SBC-REQ message to the terminal 100 to proceed with the network entry.

The terminal 100 transmits information relating to its basic transmission capability and characteristics by sending the SBC-REQ message to the base station 130 over the channel allocated from the base station 130 in step 115. The base station 130 receiving the SBC-REQ message sends a SBC-RSP message to the terminal 100 and thus transmits information relating to its basic transmission capability and characteristics in step 117.

The base station 130 and the terminal 100 perform the network entry procedure including network authentication and key exchange in step 119, and network registration (REGistration (REG)-REQ/REG-RSP message transmission and reception) in steps 121 and 123. The terminal 100 may transmit its unique uplink signal and data to the base station 130 in step 125.

The IEEE 802.16m system may define a power control equation of the first power control scheme as Equations 1, 2 and 3.

The power control equation applicable to the initial ranging stage may be defined as Equation 1.

Pₙₑₓₜ=Pₗₐₛₜ+PowerCorrection_in_{—}RNG-ACK, or

Pₙₑₓₜ=P_{ranging}_{_{—}}^{success}+PowerCorrection_in_{—}RNG-ACK (1)

In Equation 1, Pₗₐₛₜ denotes a transmit power value used by the terminal in the previous uplink transmission, and Pₙₑₓₜ denotes a transmit power value to be used by the terminal in a next uplink transmission. P_{ranging}_{_{—}}^{success} denotes a transmit power value when the initial ranging signal is successfully received. The base station determines a power correction value based on the power value P_{ranging}_{_{—}}_{success} when the initial ranging signal is successfully received and transmit channel information analyzed using the initial ranging signal. The base station sends the determined power correction value to the terminal using a next transmit signal (the RNG-ACK message in the IEEE 802.16m). PowerCorrection_in_RNG-ACK denotes the power correction value carried by the RNG-ACK message to the terminal. The terminal may determine the power value of the initial ranging stage as the sum of Pₗₐₛₜ and PowerCorrection_in_RNG-ACK or the sum of P_{ranging}_{_{—}}_{success} and PowerCorrection_in_RNG-ACK.

The power control equation applicable before the terminal obtains its STID may be defined as Equation 2.

Pₙₑₓₜ=Pₗₐₛₜ+PowerCorrection_in_{—}CDMA_Allocation_{—}IE (2)

After the initial ranging signal is transmitted and the corresponding RNG_ACK message is received, the terminal may not receive its own downlink signal and data using the STID until the STID (including the temporary STID) is allocated from the base station. Likewise, the terminal may not receive uplink transmit channel allocation information through a MAP, and is allocated through another particular signal (CDMA_Allocation_IE in the IEEE 802.16m) rather than the MAP. The base station transmits the particular signal including the power correction value to the terminal, and PowerCorrection_in_CDMA_Allocation_IE denotes the power correction value carried by CDMA_Allocation_IE to the terminal. The terminal may determine the sum of Pₗₐₛₜ and PowerCorrection_in_CDMA_Allocation_IE as the power value before its STID is obtained.

The power control equation applicable after the terminal obtains its STID may be defined for a data channel and a control channel respectively, as expressed in Equation 3.

Pₙₑₓₜ=Pₗₐₛₜ+Qffset_{Data}

Pₙₑₓₜ=Pₗₐₛₜ+Offset_{Control} (3)

After being allocated the STID (including the temporary STID) from the base station, the terminal may receive its own downlink signal and data using the STID. The base station sends an uplink power adjust message (UL_POWER_ADJUST message in the IEEE 802.16m) including the power correction value, to the terminal. Offset_{Data} and Offset_{Control} denote the power correction value for the data channel and the control channel respectively, carried by the UL_POWER_ADJUST message to the terminal. With the sum of Pₗₐₛₜ and Offset_{Data}, the terminal may determine the power value for the data channel after its STID is obtained. With the sum of Pₗₐₛₜ and Offset_{Control}, the terminal may determine the power value for the control channel after its STID is obtained.

The first power control scheme may set a particular feedback value according to a periodic or specific time, a specific condition, and a specific transmission step. By means of the set feedback, accuracy of the uplink power control of the terminal may be enhanced.

The power control equations of the second power control scheme in the IEEE 802.16m system may be defined for the data channel and the control channel as expressed in Equation 4 and Equation 5.

$$P ( dBm ) = L + NI + {SINR}_{Target} + {Offset}_{Data} \\ wherein \\ {SINR}_{Target} = 10 {log}_{10} ( max ( \begin{matrix}{10}^{( \frac{{SINR}_{M I N} ( d B )}{10} )} , \\ {γ}_{IoT} \times {SIR}_{DL} - α\end{matrix} ) ) - β \times 10 log 10 ( TNS ) \qquad ( 4 )$$

P(dbm)=L+NI+SINR_{T arg et}+Offset_{Control} (5)

wherein SINR_{T arg et}: a value defined per control signal using the SCD message

P denotes the transmit power value determined based on the corresponding power control equation and is expressed on a dBm basis. L denotes a path loss value of the propagation between the base station and the terminal and is measured by the terminal itself using the downlink signal. NI denotes an interference and noise value of a neighbor cell according to the uplink transmission and is delivered by a ULPC_NI message from the base station to the terminal periodically or aperiodically according to a certain condition.

SINR_{T arg et} denotes a value indicating a target signal to interference and noise ratio. SINR_{T arg et} in Equation 4 is determined by SINR_{DL}, SINR_{MIN}, γ_{IoT}, α, and β. SIR_{DL} denotes a value indicating a signal to interference and noise ratio and is measured by the terminal itself using the downlink signal. SINR_{MIN}, and γ_{IoT}, α, and β are transmitted from the base station to the terminal using the SCD message. SINR_{MIN} denotes a value indicating a minimum signal interference and noise ratio, and γ_{IoT} denotes an Interference over Thermal (IoT) control element. α denotes an element according to the number of base station receive antennas, and β denotes a value defined as a certain value to determine effect of Total Number of Streams (TNS) in SiNR_{T arg et}. The TNS indicates the total number of streams in a Logical Resource Unit (LRU).

SINR_{T arg et} in Equation 5 denotes a value defined by the base station per control signal and carried to the terminal using the SCD message. offset, which is the transmit power correction value, is transmitted from the base station to the terminal using the UL_POWER_ADJUST message. Offset_{Data} denotes the transmit power correction value for the data channel, and Offset_{Control} denotes the transmit power correction value for the data channel.

Before changing the power control scheme from the first power control scheme to the second power control scheme in the wireless communication system, the terminal generates the power control transition message, sends the power control transition message to the base station in the uplink, and then changes its power control scheme. For doing so, signal flows between the base station and the terminal are described below.

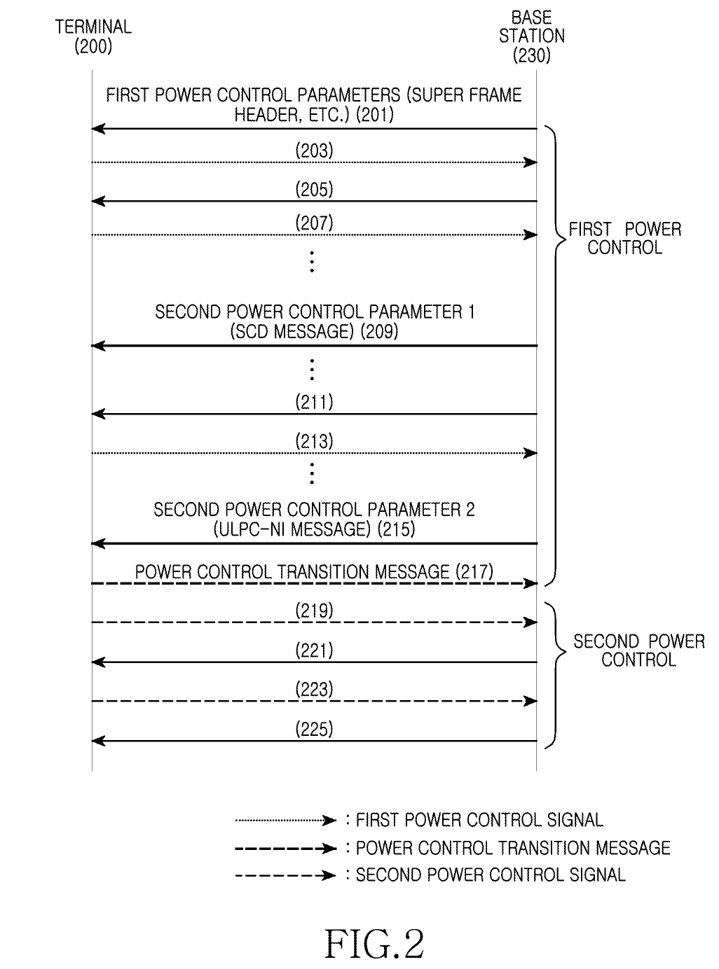

FIG. 2 is a signal flow diagram of a method of a terminal for generating and sending a power control transition message before changing a power control scheme in a wireless communication system according to an exemplary embodiment of the present invention.

Referring to FIG. 2, a base station 230 sends first power control parameters to a terminal 200 using the SFH or a known signal until the period is short or the first power control scheme is activated in step 201. The terminal 200 determines the transmit power value in the first power control scheme by receiving and using the first power control parameters, and sends an uplink signal with the determined transmit power value in step 203.

The sending of the first power control parameters from the base station 230 to the terminal 200 (step 201) and the sending of the uplink signal from the terminal 200 with transmit power value determined using the first power control parameters (step 203) continue until the base station 230 completes the transmission of all the second power control parameters (i.e., the second power control parameter 1 and the second power control parameter 2) to the terminal 200 in steps 205, 207, 211, and 213.

During the steps 201 and 203, when it is time to send the second power control parameter 1, the base station 230 sends the second power control parameter 1 to the terminal 200 using, for example, the SCD message of the IEEE 802.16m in step 209. Upon receiving part of the second power control parameters, the terminal 200 stores the parameter and transmits an uplink signal using the first power control parameter continuously received from the base station 230.

When it is time to send the second power control parameter 2, the base station 230 sends the second power control parameter 2 to the terminal 200 using, for example, the ULPC_NI message of the IEEE 802.16m in step 215. Upon receiving part of the second power control parameters, the terminal 200 stores the parameter and sends the power control transition message to the base station 230 to inform the base station 230 of the change of the power control scheme used by the terminal 200 in step 217. In this fashion, the terminal 200 may inform the base station 230 of the transition from the first power control scheme to the second power control scheme.

The terminal 200 sending the power control transition message determines the transmit power value in the second power control scheme using the second power control parameter 1 and the second power control parameter 2 received, and transmits the uplink signal with the determined transmit power value in steps 219 and 223.

The base station 230 receiving the power control transition message recognizes that the terminal 200 changes its power control scheme, and then sends the parameters relating to the power control in steps 221 and 225.

The present power control scheme transition method may be divided largely into a method in which the terminal actively sends the power control transition method or requests the required bandwidth, and a method in which the base station subjectively determines and allocates a power control transition message channel to the terminal so that the terminal may send the power control transition message before the terminal request, when a certain time or a time limit is exceeded.

The method in which the terminal actively sends the power control transition method or requests the required bandwidth may be subdivided into three methods. The first method enables the terminal to send the power control transition message by using some available data bits in a bandwidth request indicator. The second method enables the terminal to request subchannel allocation to send the power control transition message to the base station using the bandwidth request indicator. The third method is to piggyback and send the power control transition message on data currently transmitting or data to transmit by using a piggyback scheme defined in the IEEE 802.16m system. For doing so, an extension header for the piggybacked power control transition message should be defined. The terminal sends the power control transition message using the corresponding extension header. As such, when the terminal actively sends the power control transition message or requests the corresponding bandwidth, the base station only needs to wait to receive the bandwidth request indicator for the unilateral power control transition message transmission from the terminal, or to receive the power control transition message from the terminal.

The base station receiving the power control transition message from the terminal should determine allocation subchannel and transmission method of the next uplink signal of the corresponding terminal, and MCS levels. When receiving only the power control transition message from the terminal, the base station may not determine the transmission method and the MCS level when the terminal transitions from the first power control scheme to the second power control scheme. When the power control equation of the second power control scheme includes the power control parameter (i.e., L and SIR_{DL} of Equation 4, L of Equation 5) measured and reflected by the terminal itself, the base station may not know this value and the change value of the transmit power.

Exemplary embodiments of the present invention provide a method of the terminal for determining, upon transmitting the power control transition message, a difference between the transmit power value determined in the second power control scheme and the transmit power value previously determined and transmitted in the first power control scheme, and sending the determined transmit power change value to the base station together with the power control transition message. The change value of the transmit power may be determined based on Equation 6.

Δtransition=P_{TXnew,initi}−P_{TXold,last} (6)

Δtransition denotes the change value of the transmit power, P_{TXnew,initi} denotes the transmit power value determined in the second power control scheme, and P_{TXold,last} denotes the transmit power value previously determined and transmitted in the first power control scheme.

The base station, upon receiving the change value of the transmit power, determines the sum of a required Carrier to Noise ratio (C/N) value of the MCS level allocated for the previous signal of the corresponding terminal, and the received change value of the transmit power, compares the determined value with MCS levels newly allocable, and selects the greatest required C/N value from the required C/N values which are smaller or equal to the determined value. The base station may allocate the MCS level corresponding to the selected C/N value as the MCS level for the channel transmitted after the power control transition. Herein, the C/N value may be selected based on Equation 7.

$${arg max}_{m} ( C / {N ( m )}_{req} ) \leq C / {N}_{last} + Δ transition \qquad ( 7 )$$

Δtransition denotes the change value of the transmit power, and C/Nₗₐₛₜ denotes the required C/N value of the MCS level allocated for the previous signal of the corresponding terminal.

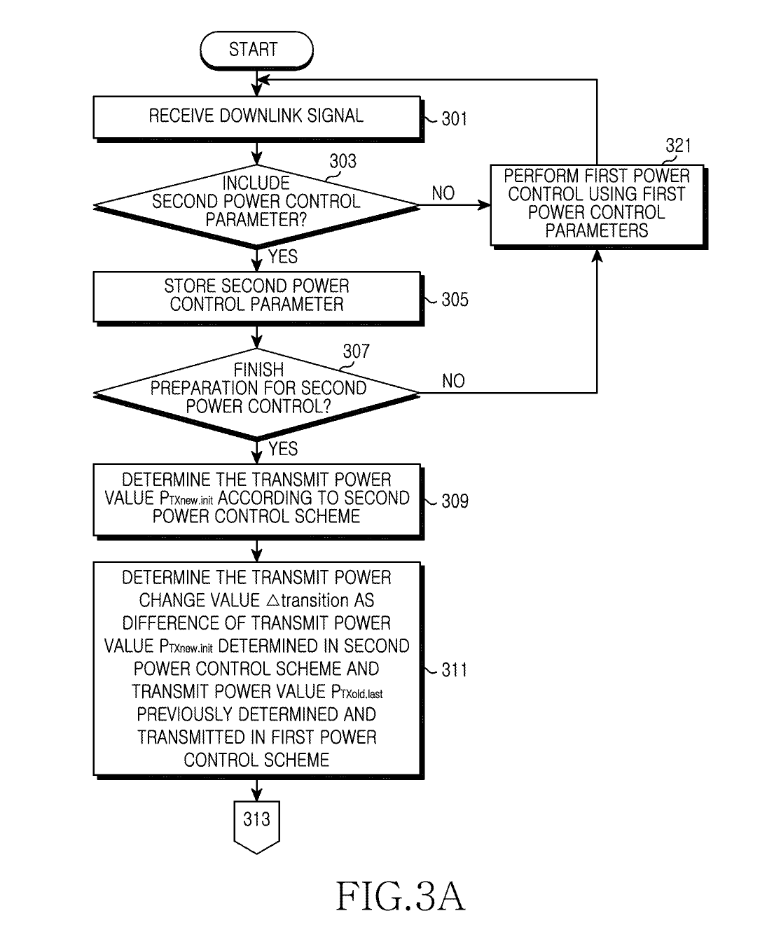

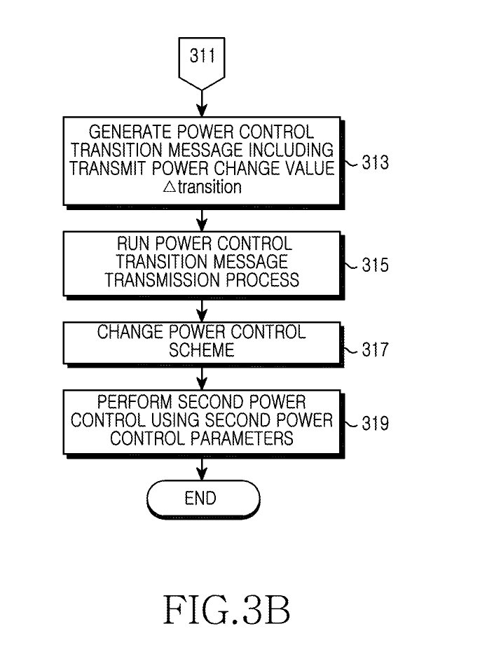

FIGS. 3A and 3B are flowcharts of a method of a terminal for sending a power control transition message to the base station before changing a power control scheme in a wireless communication system according to an exemplary embodiment of the present invention.

Referring to FIG. 3A, the terminal receives the downlink signal from the base station in step 301. In step 303, the terminal determines whether the received downlink signal includes the second power control parameters.

When the received downlink signal includes the first power control parameter, rather than the second power control parameter, in step 303, the terminal performs the first power control according to the first power control scheme using the first power control parameter in step 321 and then goes back to step 301. The terminal determines the transmit power value based on the first power control equation in the first power control scheme, and sends the uplink signal of the first power control based on the determined transmit power value. The first power control equation may be defined as Equation 1, Equation 2, and Equation 3.

When the received downlink signal includes the second power control parameter in step 303, the terminal stores the second power control parameter in its memory in step 305.

In step 307, the terminal determines whether the preparation for the second power control is complete. The terminal determines whether all of the second power control parameters to use in the second power control scheme are received.

If the preparation for the second power control is not complete in step 307, the terminal conducts the first power control according to the first power control scheme using the first power control parameters in step 321 and then returns to step 301.

When the preparation for the second power control in step 307 is complete, the terminal determines the transmit power value P_{TXnew,initi} in the second power control scheme using the second power control parameters stored to the memory in step 309.

In step 311, the terminal determines the transmit power change value Δtransition as the difference of the transmit power value P_{TXnew,initi} determined in the second power control scheme and the transmit power value P_{TXold,last} previously determined and transmitted in the first power control scheme. the transmit power change value Δtransition may be determined based on Equation 6.

Referring to FIG. 3B, the terminal generates a power control transition message including the determined transmit power change value Δtransition in step 313.

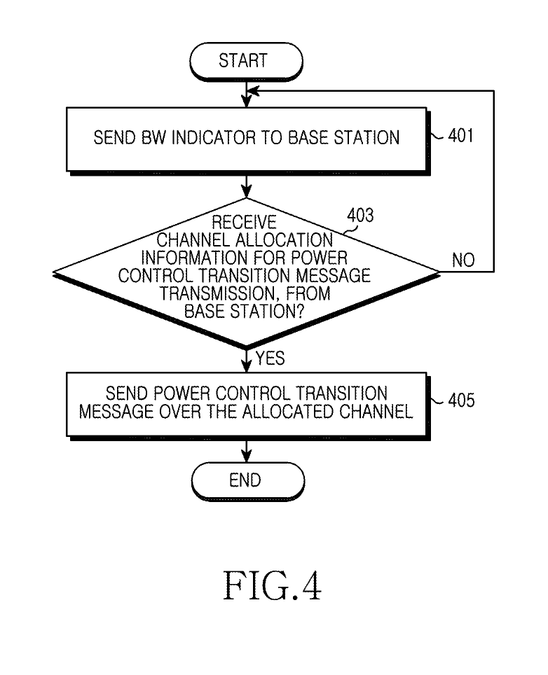

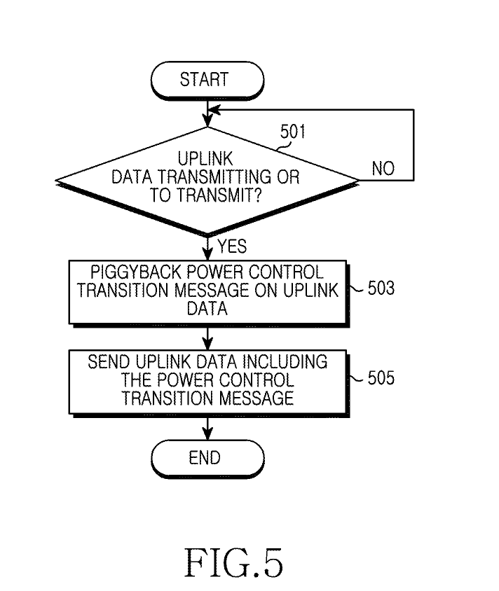

In step 315, the terminal runs a power control transition message transmission process and sends the generated power control transition message to the base station. The power control transition message transmission process is described below with respect to FIGS. 4 and 5.

In step 317, the terminal changes its power control scheme from the first power control scheme to the second power control scheme.

In step 319, the terminal conducts the second power control according to the second power control scheme using the second power control parameters stored to the memory. The terminal determines the transmit power value based on the second power control equation according to the second power control scheme, and sends the uplink signal of the second power control based on the determined transmit power value. The second power control equation may be defined as Equation 4 and Equation 5.

FIG. 4 is a flowchart of a process of a terminal for sending a power control transition message to a base station in a wireless communication system according to an exemplary embodiment of the present invention.

Referring to FIG. 4, the terminal requests the channel allocation for sending the power control transition message by sending a BandWidth (BW)-REQ indicator to the base station in step 401. The base station may allocate the channel for sending the power control transition message as requested by the terminal, and send channel allocation information corresponding to the allocated channel to the terminal.

In step 403, the terminal determines whether the channel allocation information for sending the power control transition message is received from the base station within a predetermined time.

If the terminal does not receive the channel allocation information for sending the power control transition message from the base station within the predetermined time in step 403, the terminal goes back to step 401.

Upon receiving the channel allocation information for sending the power control transition message from the base station within the predetermined time in step 403, the terminal sends the power control transition message to the base station over the allocated channel in step 405. Thus, the base station may change the power control scheme information of the terminal by receiving the power control transition message.

FIG. 5 is a flowchart of another process of a terminal for sending a power control transition message to a base station in a wireless communication system according to an exemplary embodiment of the present invention.

Referring to FIG. 5, the terminal determines whether there is uplink data currently transmitting or to be transmitted in step 501.

When it is determined in step 501 that the uplink data is currently transmitting or will be transmitted, the terminal piggybacks the power control transition message on the uplink data in step 503.

In step 505, the terminal sends the uplink data including the power control transition message to the base station. Accordingly, the base station may change the power control scheme information of the terminal by extracting the power control transition message attached to the uplink data.

In addition to the exemplary embodiments shown in FIG. 4 or FIG. 5, the terminal may send the power control transition message to the base station by using some available data bits in the BW-REQ indicator according to yet another power control transition message transmission process for sending the power control transition message to the base station. The base station may change the power control scheme information of the terminal by confirming the available data bits in the BW-REQ indicator.

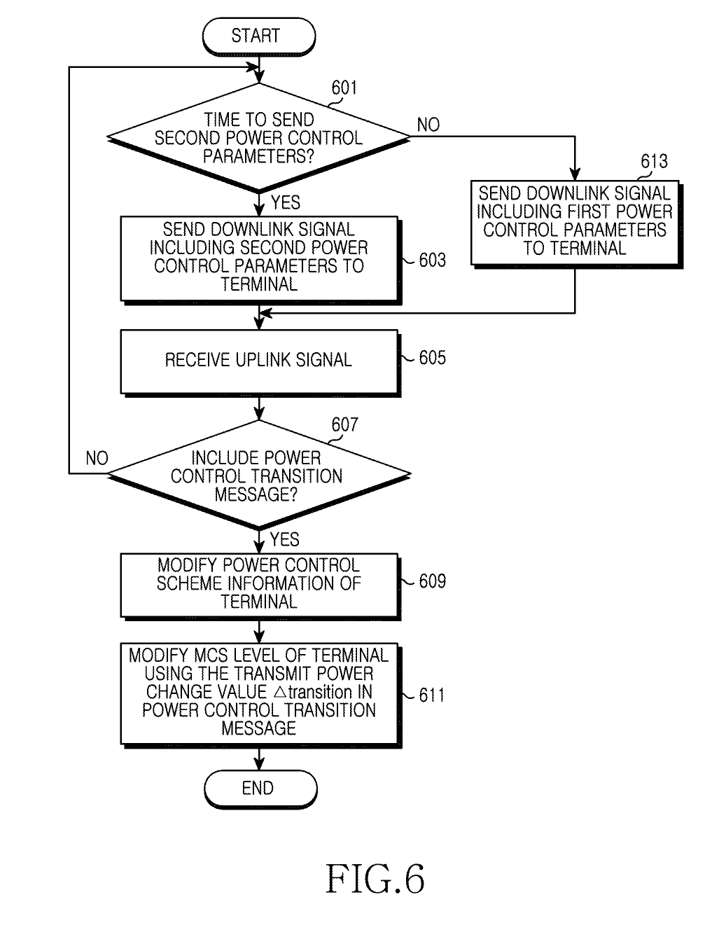

FIG. 6 is a flowchart of a method of a base station for receiving a power control transition message from a terminal in a wireless communication system according to an exemplary embodiment of the present invention.

Referring to FIG. 6, the base station determines whether it is time to send the second power control parameters in step 601.

If it is determined in step 601 that it is not time to send the second power control parameters, the base station sends the downlink signal including the first power control parameters to the terminal in step 613 and then goes to step 605.

When it is determined in step 601 to be time to send the second power control parameters, the base station sends the downlink signal including the second power control parameters to the terminal in step 603 and then goes to step 605.

In step 605, the base station receives the uplink signal from the terminal. In step 607, the base station determines whether the received uplink signal includes the power control transition message.

When the received uplink signal includes no power control transition message in step 607, the base station returns to step 601 to repeat the subsequent step until the received uplink signal includes the power control transition message.

When the received uplink signal includes the power control transition message in step 607, the base station recognizes that the power control scheme of the terminal is switched from the first power control scheme to the second power control scheme and thus changes the power control scheme information of the terminal in step 609.

In step 611, the base station modifies the MCS level of the terminal using the transmit power change value Δtransition of the power control transition message. The MCS level of the terminal may be changed using Equation 7.

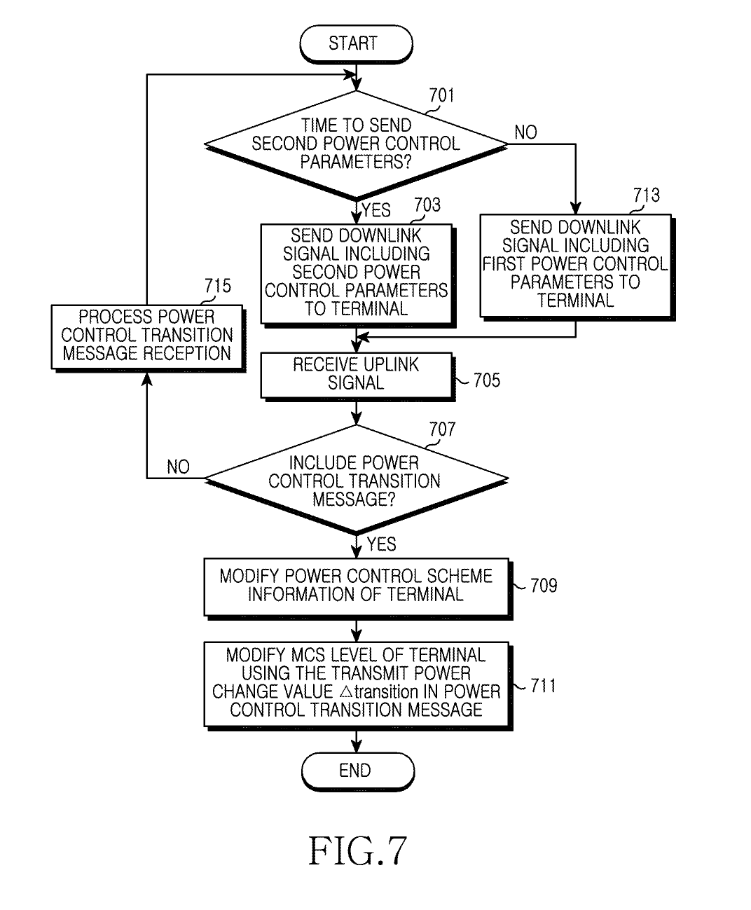

FIG. 7 is a flowchart of a method of a base station for receiving a power control transition message from a terminal in a wireless communication system according to an exemplary embodiment of the present invention.

Referring to FIG. 7, the base station determines whether it is time to send the second power control parameters in step 701.

When it is determined in step 701 that it is not time to send the second power control parameters, the base station sends the downlink signal including the first power control parameters to the terminal in step 713 and then goes to step 705.

When it is determined in step 701 that it is time to send the second power control parameters in step 701, the base station sends the downlink signal including the second power control parameters to the terminal in step 703 and then goes to step 705.

In step 705, the base station receives the uplink signal from the terminal. In step 707, the base station determines whether the received uplink signal includes the power control transition message.

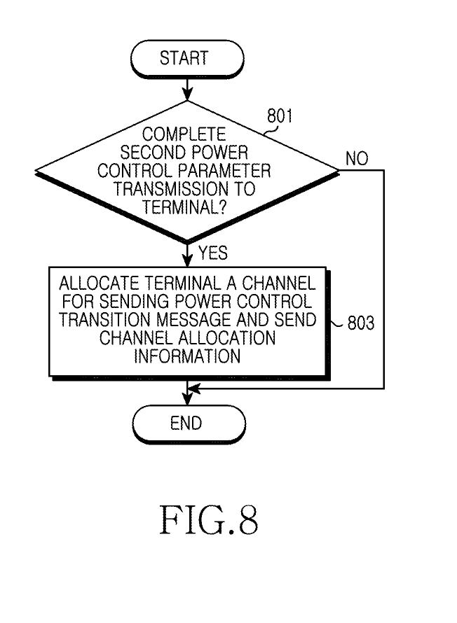

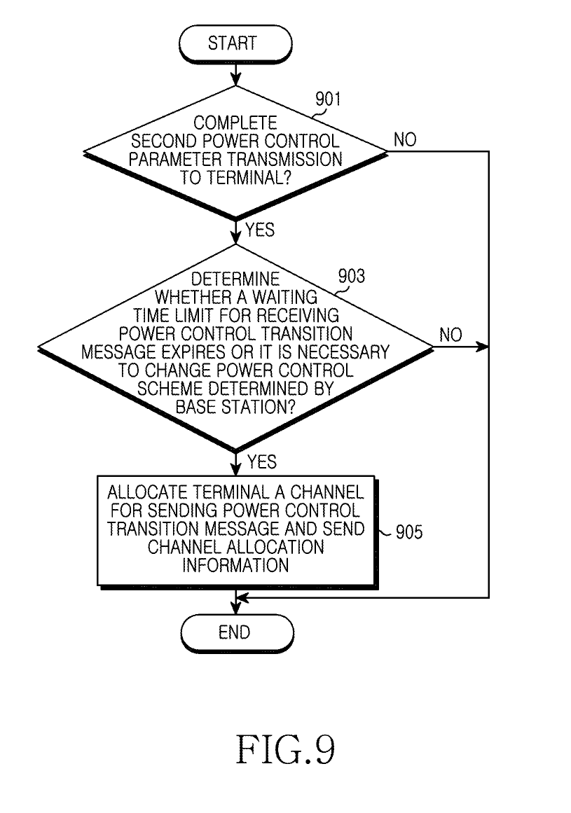

When the received uplink signal includes no power control transition message in step 707, the base station runs a power control transition message reception process and allocates the channel for sending the power control transition message to the terminal in step 715, and then goes back to step 701. The power control transition message reception process is described below with respect to FIGS. 8 and 9.

When the received uplink signal includes the power control transition message in step 707, the base station recognizes that the power control scheme of the terminal is switched from the first power control scheme to the second power control scheme and thus changes the power control scheme information of the terminal in step 709.

In step 711, the base station modifies the MCS level of the terminal using the transmit power change value Δtransition of the power control transition message. The MCS level of the terminal may be changed using Equation 7.

FIG. 8 is a flowchart of the process of a base station for receiving a power control transition message from a terminal in a wireless communication system according to an exemplary embodiment of the present invention.

Referring to FIG. 8, the base station determines in step 801 whether the transmission of the second power control parameters to the terminal is complete.

When it is determined in step 801 that the transmission of the second power control parameters to the terminal is not complete, the process ends.

When it is determined in step 801 that the transmission of the second power control parameters to the terminal is complete, the base station allocates the channel for sending the power control transition message to the terminal and sends channel allocation information corresponding to the allocated channel in step 803. Accordingly, the terminal may send the power control transition message to the base station over the allocated channel.

FIG. 9 is a flowchart of a process of a base station for receiving the power control transition message from a terminal in a wireless communication system according to an exemplary embodiment of the present invention.

Referring to FIG. 9, the base station determines in step 901 whether the transmission of the second power control parameters to the terminal is complete.

When it is determined in step 901 that the transmission of the second power control parameters to the terminal is not complete, the process ends.

When it is determined in step 901 that the transmission of the second power control parameters to the terminal is complete, the base station determines whether a waiting time limit for receiving the power control transition message has expired or it is necessary to change the power control scheme determined by the base station in step 903.

When the waiting time limit for receiving the power control transition message has not expired and it is not necessary to change the power control scheme determined by the base station in step 903, the process ends.

When the waiting time limit for receiving the power control transition message expires or it is necessary to change the power control scheme determined by the base station in step 903, the base station allocates the channel for sending the power control transition message to the terminal and sends channel allocation information corresponding to the allocated channel in step 905. Accordingly, the terminal may send the power control transition message to the base station over the allocated channel.

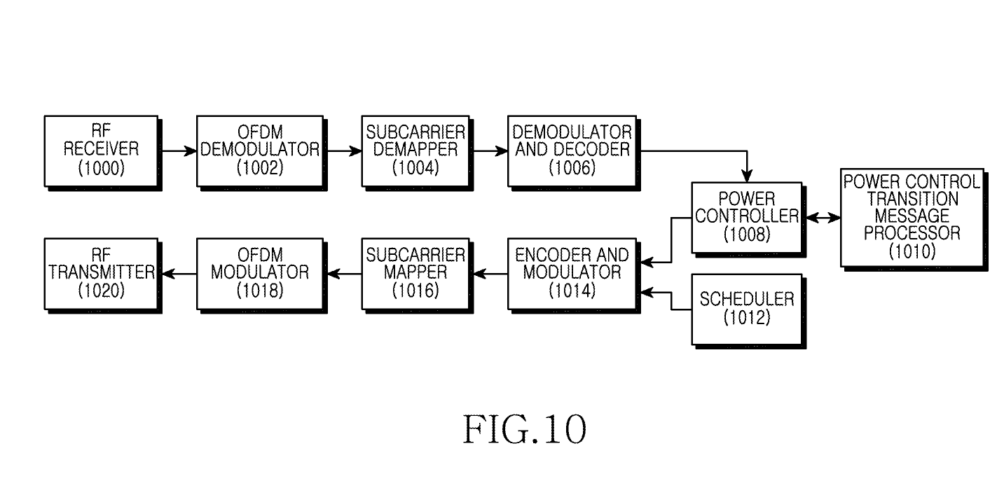

FIG. 10 is a block diagram of a base station in a wireless communication system according to an exemplary embodiment of the present invention.

Referring to FIG. 10, the base station includes a Radio Frequency (RF) receiver 1000, an OFDM demodulator 1002, a subcarrier demapper 1004, a demodulator and decoder 1006, a power controller 1008, a power control transition message processor 1010, a scheduler 1012, an encoder and modulator 1014, a subcarrier mapper 1016, an OFDM modulator 1018, and an RF transmitter 1020. The base station may include additional and/or different units. Similarly, the functionality of two or more of the above units may be integrated into a single component.

The RF receiver 1000 down-converts and digitizes an RF signal received via an antenna to a baseband signal. The OFDM demodulator 1002 divides the received signal into OFDM symbols, removes a Cyclic Prefix (CP), and then restores the signals per subcarrier using Fast Fourier Transform (FFT). The subcarrier demapper 1004 classifies and demaps complex symbols mapped to the subcarriers on a logical basis. The demodulator and decoder 1006 demodulates and decodes the complex symbols to an information bit string.

The power controller 1008 sends the first power control parameters to the terminal by providing the first power control parameter to the encoder and modulator 1014 until the second power control parameters are transmitted, and sends the second power control parameters to the terminal by providing the second power control parameters to the encoder and modulator 1014 when the second power control parameters are transmitted. The power controller 1008 waits to receive the power control transition message from the terminal. Upon receiving the power control transition message from the terminal through the demodulator and decoder 1006, the power controller 1008 recognizes the transition of the power control scheme of the terminal and modifies the power control scheme information of the terminal.

The power controller 1008 provides the power control transition message to the power control transition message processor 1010 to obtain the transmit power change value in the power control transition message, and determines or alters the MCS level of the terminal using the obtained transmit power change value. Alternatively, the power controller 1008 determines the transmission completion of the second power control parameters to the terminal, and the expiration of the power control transition message reception waiting time limit or the necessary time to change the power control scheme as determined by the base station, allocates the channel for sending the power control transition message to the terminal, provides the channel allocation information to the terminal via the encoder and modulator 1014, and thus receives the power control transition message from the terminal through the demodulator and decoder 1006.

The power control transition message processor 1010 receives the power control transition message from the power controller 1008, and extracts and provides the transmit power change value in the power control transition message to the power controller 1008.

The scheduler 1012 schedules the uplink/downlink data, and provides the encoder and modulator 1014 with resource allocation information for the scheduled data and the corresponding data according to the scheduling result.

The encoder and modulator 1014 encodes and modulates the information bit string to the complex symbols. The subcarrier mapper 1016 maps the complex symbols to the subcarriers. A control signal is mapped to a designated subcarrier, and a data signal is mapped according to the scheduling result of the scheduler 1012. The OFDM modulator 1018 applies Inverse FFT (IFFT) to the signals mapped to the subcarriers, and generates a time-domain OFDM symbol by inserting the CP. The RF transmitter 1020 converts the OFDM symbol to an analog signal, up-converts the analog signal to an RF signal, and transmits the RF signal over the antenna.

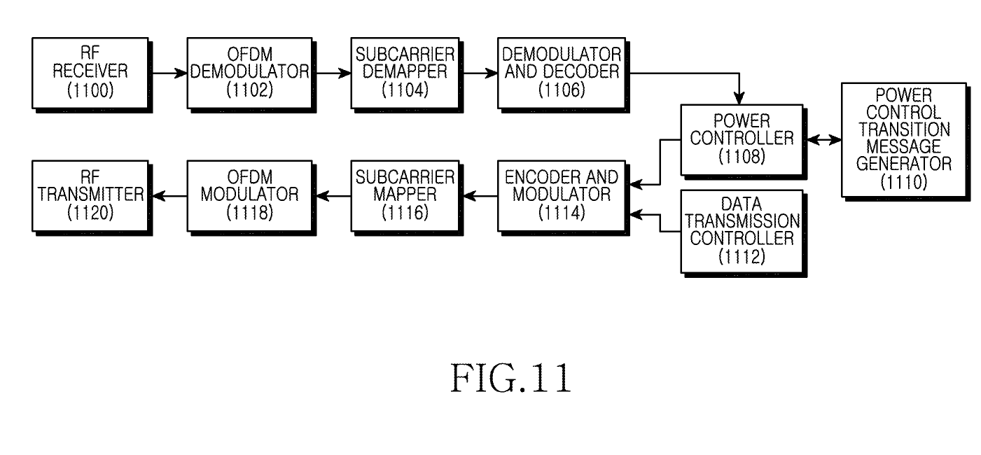

FIG. 11 is a block diagram of a terminal in a wireless communication system according to an exemplary embodiment of the present invention.

Referring to FIG. 11, the terminal of FIG. 11 includes an RF receiver 1100, an OFDM demodulator 1102, a subcarrier demapper 1104, a demodulator and decoder 1106, a power controller 1108, a power control transition message generator 1110, a data transmission controller 1112, an encoder and modulator 1114, a subcarrier mapper 1116, an OFDM modulator 1118, and an RF transmitter 1120. The terminal may include additional and/or different units, depending on the nature of the terminal. In addition, two or more of the above units may be integrated into a single component.

The RF receiver 1100 down-converts and digitizes an RF signal received via an antenna to a baseband signal. The OFDM demodulator 1102 divides the received signal into OFDM symbols, removes the CP, and then restores the signal per subcarrier using the FFT. The subcarrier demapper 1104 classifies and demaps complex symbols mapped to the subcarriers on the logical basis. The demodulator and decoder 1106 demodulates and decodes the complex symbols to an information bit string.

The power controller 1108 receives the first power control parameter or the second power control parameters from the base station through the demodulator and decoder 1106, and performs the first power control using the first power control parameters until the preparation for the second power control is complete. The power controller 1108 stores the first power control parameters or the provided second power control parameters in a memory (not shown). When the preparation for the second power control is complete, the power controller 1108 determines the transmit power value P_{TXnew,initi} according to the second power control scheme using the second power control parameters stored to the memory (not shown), and determines the difference of the transmit power value P_{TXnew,initi} determined in the second power control scheme and the transmit power value P_{TXold,last} previously determined and transmitted in the first power control scheme, as the transmit power change value Δtransition.

The power controller 1108 provides the power control transition message generator 1110 with the determined transmit power change value Δtransition, obtains the power control transition message including the determined transmit power change value Δtransition, and sends the power control transition message to the base station by providing the obtained power control transition message to the encoder and modulator 1114. The power controller 1108 changes the power control scheme from the first power control scheme to the second power control scheme, and conducts the second power control using the second power control parameters.

The power control transition message may be transmitted to the base station in various schemes. The power controller 1108 may set some available data bits in the BW indicator, provide the bits to the encoder and modulator 1114, and thus send the power control transition message to the base station. The power controller 1108 may send the BW indicator requesting the channel allocation for sending the power control transition message, to the base station via the encoder and modulator 1114, be allocated the channel from the base station through the demodulator and decoder 1106, and then send the power control transition message over the allocated channel. The power controller 1108 may control to piggyback the power control transition message on the data currently transmitting or the data to transmit by providing the power control transition message to the encoder and modulator 1114, and thus send the power control transition message to the base station.

The power control transition message generator 1110 receives the transmit power change value Δtransition from the power controller 1108, generates the power control transition message including the determined transmit power change value Δtransition, and outputs the generated power control transition message to the power controller 1108.

The data transmission controller 1112 controls the transmission of the uplink data, and provides the uplink data to the encoder and modulator 1114 under the control.

The encoder and modulator 1114 encodes and modulates the information bit string to the complex symbols. The subcarrier mapper 1116 maps the complex symbols to the subcarriers. The OFDM modulator 1118 applies the IFFT to the signals mapped to the subcarriers, and generates a time-domain OFDM symbol by inserting the CP. The RF transmitter 1120 converts the OFDM symbol to an analog signal, up-converts the analog signal to an RF signal, and transmits the RF signal over the antenna.

As set forth above, when the power control schemes are used in the wireless communication system, a transition from one power control scheme (i.e., the first power control scheme) to the other power control scheme (i.e., the second power control scheme) should be made. When the latter power control scheme (i.e., the second power control scheme) is ready before the terminal changes its power control scheme, the terminal sends the power control transition message to the base station. Accordingly, it is possible to eliminate the confusion of the power control scheme at the base station and to avoid inaccurate power control.

In addition, the terminal determines the difference of the transmit power value determined in the second power control scheme and the transmit power value previously determined and transmitted in the first power control scheme, and sends the result value to the base station together with the power control transition message. As a result, even when the power control scheme is changed, the base station may adaptively set the MCS level. Consequently, the data transmission efficiency before the transition may be maintained.

While the invention has been shown and described with reference to certain exemplary embodiment thereof, it will be understood by those one skilled in the art that various changes in form and details may be made therein without departing from the spirit and scope of the invention as defined by the appended claims and their equivalents.

What is claimed is:

1. A method of a terminal for changing a power control scheme in a wireless communication system, the method comprising:
controlling power according to a first power control scheme based on first power control parameters received from a base station;
receiving second power control parameters to use in a second power control scheme, from the base station;
sending a power control transition message informing the base station of a transition of the power control scheme, to the base station; and
controlling the power according to the second power control scheme based on the second power control parameters.

2. The method of claim 1, wherein a power control equation according to the first power control scheme is defined as the following equation:
Pₙₑₓₜ=Pₗₐₛₜ+PowerCorrection_in_{—}RNG-ACK, or
Pₙₑₓₜ=P_{ranging}_{_{—}}^{success}+PowerCorrection_in_{—}RNG-ACK
where the power control equation according to the first power control scheme is applied to an initial ranging stage, Pₗₐₛₜ denotes a transmit power value used by the terminal in a previous uplink transmission, Pₙₑₓₜ denotes a transmit power value to be used by the terminal in a next uplink transmission, P_{ranging}_{_{—}}^{success} denotes a transmit power value when an initial ranging signal is successfully received, PowerCorrection_in_RNG-ACK denotes a power correction value carried by a RaNGing (RNG)-Acknowledge (ACK) message to the terminal, and the power correction value is determined by the base station based on transmit channel information analyzed using the power value P_{ranging}_{_{—}}_{success} when the initial ranging signal is successfully received and the initial ranging signal.

3. The method of claim 1, wherein a power control equation according to the first power control scheme is defined as the following equation:
Pₙₑₓₜ=Pₗₐₛₜ+PowerCorrection_in_CDMA_Allocation_IE
where the power control equation according to the first power control scheme is applied before the terminal obtains a STation ID (STID), Pₗₐₛₜ denotes a transmit power value used by the terminal in a previous uplink transmission, Pₙₑₓₜ denotes a transmit power value to be used by the terminal in a next uplink transmission, and PowerCorrection_in_CDMA_Allocation_IE denotes a power correction value carried by a Code Division Multiple Access (CDMA)_Allocation_IE to the terminal.

4. The method of claim 1, wherein a power control equation according to the first power control scheme is defined as the following equation:
Pₙₑₓₜ=Pₗₐₛₜ+Offset_{Data}
Pₙₑₓₜ=Pₗₐₛₜ+Offset_{Control}
where the power control equation according to the first power control scheme is applied after the terminal obtains an STID, Pₗₐₛₜ denotes a transmit power value used by the terminal in a previous uplink transmission, Pₙₑₓₜ denotes a transmit power value to be used by the terminal in a next uplink transmission, and Offset_{Data} and Offset_{Control} denote a power correction value for a data channel and a control channel respectively, which are carried by an uplink power adjust message to the terminal.

5. The method of claim 1, further comprising:
determining a transmit power value according to the second power control scheme using the second power control parameters;
determining a transmit power change value as a difference of the transmit power value determined according to the second power control scheme and a previous transmit power value determined and transmitted according to the first power control scheme; and
generating a power control transition message comprising the determined transmit power change value,
wherein the transmit power change value is determined based on the following equation:
Δtransition=P_{TXnew,initi}−P_{TXold,last}
where Δtransition denotes the transmit power change value, P_{TXnew,initi} denotes the transmit power value determined in the second power control scheme, and P_{TXold,last} denotes the previous transmit power value determined and transmitted in the first power control scheme.

6. The method of claim 1, wherein the sending of the power control transition message comprises:
requesting to allocate a channel for sending the power control transition message by sending a BandWidth (BW)-REQuest (REQ) indicator to the base station;
receiving channel allocation information from the base station according to the channel allocation request; and
sending the power control transition message to the base station over a channel corresponding to the received channel allocation information.

7. The method of claim 1, wherein the sending of the power control transition message comprises:
piggybacking the power control transition message on uplink data currently transmitting or to be transmitted; and
sending the uplink data attached with the power control transition message to the base station.

8. The method of claim 1, wherein the sending of the power control transition message comprises:
sending the power control transition message to the base station using data bits in a BW-REQ indicator.

9. The method of claim 1, further comprising, before sending the power control transition message:
receiving channel allocation information from the base station,
wherein the power control transition message is transmitted to the base station over a channel corresponding to the received channel allocation information.

10. A method of a base station for changing a power control scheme in a wireless communication system, the method comprising:
sending, to a terminal, first power control parameters for a first power control scheme outside a second power control parameter transmission time;
sending, to the terminal, second power control parameters for a second power control scheme at the second power control parameter transmission time;
receiving, from the terminal, a power control transition message informing the base station of a change of a power control scheme; and
modifying power control scheme information of the terminal.

11. The method of claim 10, further comprising:
extracting a transmit power change value from the power control transition message, the transmit power change value determined as a difference of a transmit power value determined by the terminal according to the second power control scheme and a previous transmit power value determined by the terminal and transmitted to the base station according to the first power control scheme; and
changing a Modulation and Coding Scheme (MCS) level of the terminal using the extracted transmit power change value.

12. The method of claim 11, wherein the changing of the MCS level of the terminal comprises:
determining a sum of a required Carrier to Noise ratio (C/N) value of the MCS level allocated for a previous signal of the terminal, and the received transmit power change value;
comparing the determined value with MCS levels newly allocable and selecting the greatest required C/N value among the required C/N values which are smaller or equal to the determined value; and
selecting an MCS level corresponding to the selected C/N value,
wherein the greatest required C/N value is selected based on the following equation:
$${arg max}_{m} ( C / {N ( m )}_{req} ) \leq C / {N}_{last} + Δ transition$$
where Δtransition denotes the transmit power change value and C/Nₗₐₛₜ denotes the required C/N value of the MCS level allocated for the previous signal of the terminal.

13. The method of claim 10, further comprising:
when completing the second power control parameter transmission to the terminal, allocating the terminal a channel for sending the power control transition message and sending channel allocation information to the terminal.

14. An apparatus of a terminal for changing a power control scheme in a wireless communication system, the apparatus comprising:
a receiver for receiving at least one of first power control parameters and second power control parameters from a base station;
a power controller for controlling power according to a first power control scheme based on the first power control parameters received from the base station through the receiver, when receiving the second power control parameters to use in a second power control scheme from the base station, for controlling the sending of a power control transition message informing the base station of a transition of the power control scheme, to the base station, and for controlling the power according to the second power control scheme using the second power control parameters; and
a transmitter for sending the power control transition message to the base station.

15. The apparatus of claim 14, wherein a power control equation according to the first power control scheme is defined as the following equation:
Pₙₑₓₜ=Pₗₐₛₜ+PowerCorrection_in_RNG-ACK, or
Pₙₑₓₜ=P_{ranging}_{_{—}}^{success}+PowerCorrection_in_{—}RNG-ACK
where the power control equation according to the first power control scheme is applied to an initial ranging stage, Pₗₐₛₜ denotes a transmit power value used by the terminal in a previous uplink transmission, Pₙₑₓₜ denotes a transmit power value to be used by the terminal in a next uplink transmission, P_{ranging}_{_{—}}^{success} denotes a transmit power value when an initial ranging signal is successfully received, PowerCorrection_in_RNG-ACK denotes a power correction value carried by a RaNGing (RNG)-Acknowledge (ACK) message to the terminal, and the power correction value is determined by the base station based on transmit channel information analyzed using the power value P_{ranging}_{_{—}}^{success} when the initial ranging signal is successfully received and the initial ranging signal.

16. The apparatus of claim 14, wherein a power control equation according to the first power control scheme is defined as the following equation:
Pₙₑₓₜ=Pₗₐₛₜ+PowerCorrection_in_CDMA_Allocation_IE
where the power control equation according to the first power control scheme is applied before the terminal obtains a STation ID (STID), Pₗₐₛₜ denotes a transmit power value used by the terminal in a previous uplink transmission, Pₙₑₓₜ denotes a transmit power value to be used by the terminal in a next uplink transmission, and PowerCorrection_in_CDMA_Allocation_IE denotes a power correction value carried by a Code Division Multiple Access (CDMA)_Allocation_IE to the terminal.

17. The apparatus of claim 14, wherein a power control equation according to the first power control scheme is defined as the following equation:
Pₙₑₓₜ=Pₗₐₛₜ+Offset_{Data}
Pₙₑₓₜ=Pₗₐₛₜ+Offset_{Control}
where the power control equation according to the first power control scheme is applied after the terminal obtains an STID, Pₗₐₛₜ denotes a transmit power value used by the terminal in a previous uplink transmission, Pₙₑₓₜ denotes a transmit power value to be used by the terminal in a next uplink transmission, and Offset_{data} and Offset_{Control} denote a power correction value for a data channel and a control channel respectively, which are carried by an uplink power adjust message to the terminal.

18. The apparatus of claim 14, further comprising:
a power control message generator for generating the power control transition message, the power control transition message comprising a transmit power change value,
wherein the power controller determines a transmit power value according to the second power control scheme using the second power control parameters, and determines a transmit power change value as a difference of the transmit power value determined according to the second power control scheme and a previous transmit power value determined and transmitted according to the first power control scheme, and
wherein the transmit power change value is determined based on the following equation:
Δtransition=P_{TXnew,initi}−P_{TXold,last}
where Δtransition denotes the transmit power change value, P_{TXnew,initi} denotes the transmit power value determined in the second power control scheme, and P_{TXold,last} denotes the previous transmit power value determined and transmitted in the first power control scheme.

19. The apparatus of claim 14, wherein the power controller requests to allocate a channel for sending the power control transition message by sending a BandWidth (BW)-REQuest (REQ) indicator to the base station through the transmitter, receives channel allocation information from the base station through the receiver, and sends the power control transition message to the base station via the transmitter over a channel corresponding to the received channel allocation information.

20. The apparatus of claim 14, wherein the power controller piggybacks the power control transition message on uplink data currently transmitting or to be transmitted, and sends the uplink data through the transmitter.

21. The apparatus of claim 16, wherein the power controller sends the power control transition message to the base station through the transmitter using data bits in a BW-REQ indicator.

22. The apparatus of claim 14, wherein, before the power control transition message is transmitted, the receiver receives channel allocation information from the base station, and
the transmitter sends the power control transition message to the base station over a channel corresponding to the received channel allocation information.

23. An apparatus of a base station for changing a power control scheme in a wireless communication system, the apparatus comprising:
a transmitter for sending, to a terminal, first power control parameters for a first power control scheme outside a second power control parameter transmission time, and for sending, to the terminal, second power control parameters for a second power control scheme at the second power control parameter transmission time;
a receiver for receiving, from the terminal, a power control transition message informing the base station of a change of a power control scheme; and
a power controller for modifying power control scheme information of the terminal.

24. The apparatus of claim 23, further comprising:
a power control transition message processor for extracting a transmit power change value from the power control transition message, the transmit power change value determined as a difference of a transmit power value determined by the terminal according to the second power control scheme and a previous transmit power value determined by the terminal and transmitted to the base station according to the first power control scheme,
wherein the power controller changes a Modulation and Coding Scheme (MCS) level of the terminal using the extracted transmit power change value.

25. The apparatus of claim 24, wherein the power controller determines a sum of a required Carrier to Noise ratio (C/N) value of the MCS level allocated for a previous signal of the terminal, and the received transmit power change value, compares the determined value with MCS levels newly allocable, selects the greatest required C/N value among the required C/N values which are smaller or equal to the determined value, and selects an MCS level corresponding to the selected C/N value,
wherein the greatest required C/N value is selected based on the following equation:
$${arg max}_{m} ( C / {N ( m )}_{req} ) \leq C / {N}_{last} + Δ transition$$
where Δtransition denotes the transmit power change value and C/Nₗₐₛₜ denotes the required C/N value of the MCS level allocated for the previous signal of the terminal.

26. The apparatus of claim 23, wherein, when completing the second power control parameter transmission to the terminal, the power controller allocates the terminal a channel for sending the power control transition message and sends channel allocation information to the terminal through the transmitter.

27. The apparatus of claim 26, wherein the power controller allocates the channel to the terminal when a time limit for receiving the power control transition message has expired or when it is necessary to change the power control scheme.
